(19) United States
(12) Patent Application Publication
(10) Pub. No.: US 2009/0111527 A1
(43) Pub. Date: Apr. 30, 2009

(54) Adhesive mounted communication device

(75) Inventors: Andrew K. Richardson, Santa Cruz, CA (US); Elizabeth A. Walikis, Aptos, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: Plantronics, Inc.

(21) Appl. No.: 11/241,473

(22) Filed: Sep. 29, 2005

(51) Int. Cl. H04M 1/00; H04R 11/04

(52) U.S. Cl. 455/569.1; 381/364

(57) ABSTRACT

Systems and methods for a communication device are disclosed. The system generally includes a housing, a microphone for converting an acoustic signal to an electrical signal disposed within the housing, a receiver for converting an electrical signal to an acoustic signal disposed within the housing, and an adhesive attached to the housing for removably adhering the housing to a user.

### BACKGROUND OF THE INVENTION

Headsets are typically worn by users using an earloop, headband, in the ear restraining mechanisms or combinations thereof. Various headsets have employed the so-called “post-auricle” configuration, wherein the transducers are placed in a capsule which is mounted behind the ear of the user, and is shaped to fit generally along the saddle area behind the ear. In one post-auricle arrangement, an acoustic voice tube is passed over the ear and into the headset capsule, and an acoustic ear tube is passed from the capsule under the wearer's ear and up into the ear canal. This arrangement is embodied in a headset commercially sold by Plantronics, Inc., the assignee of the present application, under its trademark “StarSet.”

The post-auricle headset designs in the prior art have attempted to provide stability by means of the judicious location of the acoustic voice tube or boom, by means of the anchoring effect of the acoustic ear tube, or by attempting to make the saddle curvature of the headset capsule fit as many human ears as possible.

However, these and other headset devices are not sufficiently secure for particular activities or for certain people. For instance, none of the standard donning mechanisms provide ample stability for athletic activities like running or climbing. Such devices are not designed for use in an aquatic environment, including activities such as boating or surfing. Furthermore, people with memory problems, such as those with a disease such as Alzheimer's, may not remember to wear a communication device that helps guide them through the day. In addition, users may not want to bother with cumbersome earloop or headband device.

Prior art devices such as earloops do not fit everyone and usually create hot spots of pain after an extended period of use. Furthermore, headset donning mechanisms like earloops can compromise the acoustic seal and/or performance because the fit of the headset is rigidly connected to the acoustic transmit and receive elements.

As a result, there is a need for improved methods and apparatuses for wearing, using, and positioning communication devices.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a wireless communication device in an example of the invention.

FIG. 2 illustrates disassembled perspective view of a wireless communication device in an example of the invention.

FIG. 3 illustrates a side view of a wireless communication device in an example of the invention.

FIG. 4 illustrates a user wearing the wireless communication device in an example of the invention.

### DESCRIPTION OF SPECIFIC EMBODIMENTS

Methods and apparatuses for donning of wireless mobile communication devices are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

Generally, this description describes a method and apparatus for wearing (also referred to as donning) a wireless communication device. For example, the wireless communication device may be attached to a user skin via a double sided adhesive. The present invention is applicable to a variety of different types of wireless communication devices, as well as wired devices. While the present invention is not necessarily limited to such devices, various aspects of the invention may be appreciated through a discussion of various examples using this context. In particular, the example application of the invention to a wireless communication device will be described.

According to an example of the present invention, a wireless communication device is worn by a user through the use of an adhesive. The wireless communication device is composed of flexibly coupled modules which conform to the attached user. This arrangement provides several advantages over the prior art. The adhesive wireless headset provides value to people requiring a hands-free communication device that provides ultrahigh stability with high degree of comfort and discreteness. For example, the invention is particularly useful for athletic activities. The invention can accommodate water environments easily, providing communications solutions which require water resistant devices and/or high stability.

The invention may also be advantageously used by patients with memory problems. The inventive device can be comfortably worn for an extended period of time, thereby reducing the chances of the device being misplaced and lost. Because the present wireless communication device may be worn at various locations on the body, it may be placed in a different location so as to avoid irritation from repetitive placement. Furthermore, the present inventive device offers discreet placement options.

One advantage of the present invention is that it decouples the receive and transmit elements from the other components that mount onto the body, thereby reducing compromise of the acoustic seal and/or device performance because the fit of the headset is not rigidly connected to the acoustic transmit and receive elements.

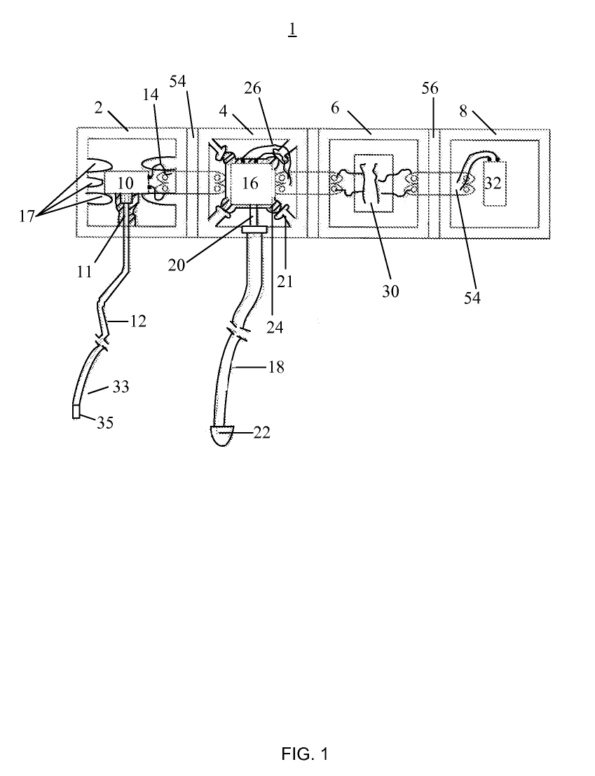

Referring to FIG. 1, a wireless communication device 1 in an example of the invention is illustrated. The wireless communication device 1 includes a transmitter module 2, receiver module 4, printed circuit board assembly (PCBA) module 6, and a battery module 8. Each module of the wireless communication device 1 may have a housing in the shape of a thin square case flexibly attached to one another by a flexible elastomeric gasket. For example, the case may be as thin as approximately 1 mm. Each module has a top surface and a rear surface. The rear surface of each module has a double sided adhesive attached. The wireless communication device 1 may then be attached to the user via the adhesive. Battery module 8 contains a power source such as a rechargeable battery 32 for providing power to the wireless communication device 1. Although four distinct modules are illustrated, in further examples the number of modules used may vary with the circuits and components described herein combined into fewer modules or separated into a greater number of modules. Although the use of two or modules offers certain advantages as described herein, wireless communication device 1 may be a single module in one example of the invention.

Receiver module 4 contains a receiver 16 for conversion of these signals to sound by a receiver transducer. The receiver's sound signals are conveyed by an acoustic ear tube 18 to the wearer's ear canal. Transmitter module 2 contains a microphone 10 for converting voice signals to electrical signals, which are then conveyed by means of electrical leads 14 to a suitable amplification device, and thence onto a communication link. Voice signals are conveyed to the microphone 10 via an acoustic sound tube 12, which may be positioned near the wearer's mouth. Alternatively, the microphone 10 might be located at the end of acoustic sound tube 12, which would then not function as an acoustic tube, but rather as a conduit tube for one or more lead wires from the microphone into the transmitter module 2.

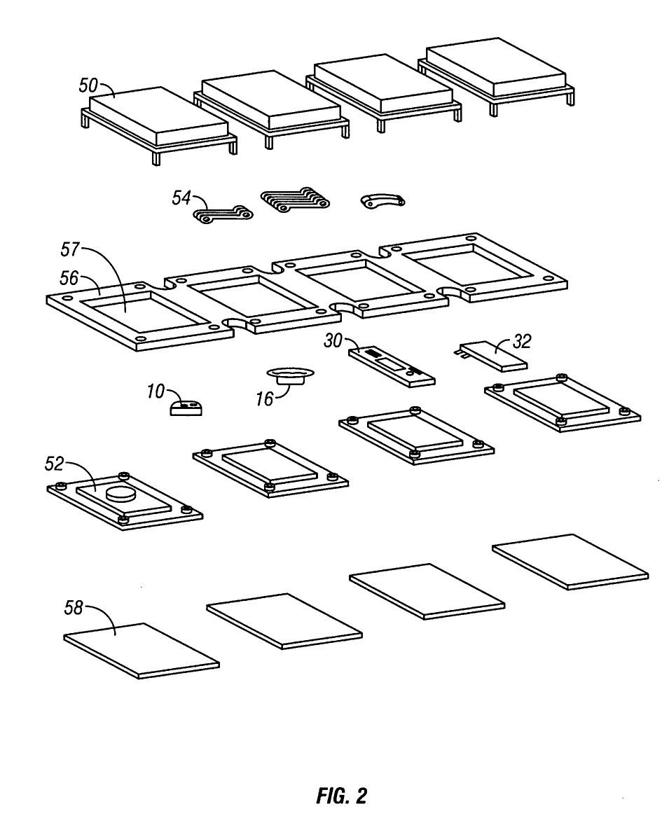

FIG. 2 illustrates disassembled perspective view of a wireless communication device in an example of the invention. Referring to FIG. 1 and FIG. 2 of the drawings, the transmitter module 2, receiver module 4, printed circuit board assembly (PCBA) module 6, and battery module 8 each are comprised of two mating halves 50 and 52. Transmitter module 2 includes microphone 10 and associated transmitter circuitry. Receiver module 4 includes a receiver 16 and associated receiver circuitry. In one example, flex circuits 54 are utilized between each module to electrically couple the modules to form a complete functioning circuit. In a further example, electrical leads may be used. A single piece flexible elastomeric gasket 56 is inserted between mating halves 50 and 52 to flexibly couple all of the modules into a single flexible wireless communication device. Elastomeric gasket 56 includes an aperture 57 for each module. Flexible elastomeric gasket 56 may comprise two or more layers, with flex circuits inserted there between. In such a configuration, the elastomeric gasket 56 serves to physically shield flex circuits 54. The two mating halves 50 and 52 may be coupled using a variety of mechanisms. For example, mating halves 50 and 52 may use a pin and socket mechanism.

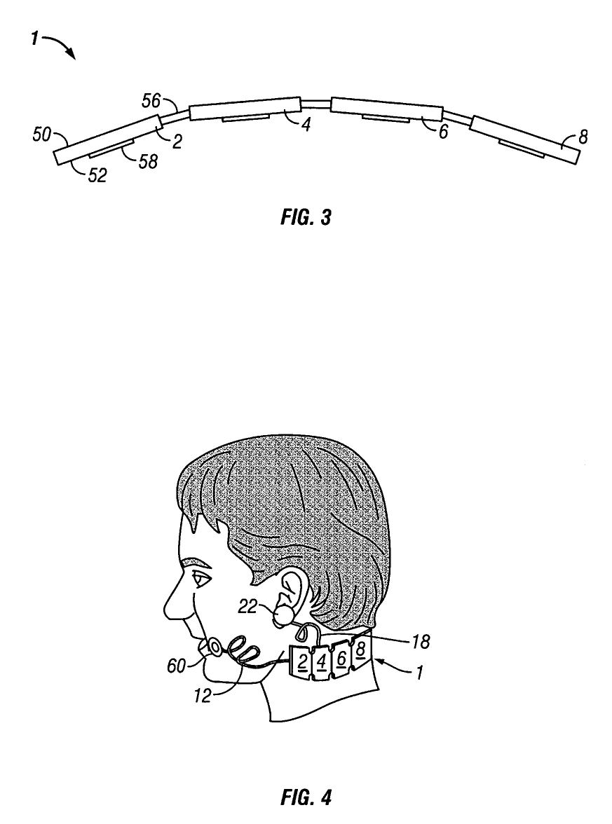

Flexible elastomeric gasket 56 is designed to allow the wireless communication device to bend and conform to the contour of the user body part to which the wireless communication device is attached. This flexibility is done to take account of the various contours of the human body in different locations. Through the use of several modules, the particular shape of the wireless communication device may be flexed between each module, resulting in a variety of positions and directions during use depending on the user body surface to which the device is attached. This freedom of positioning enables the wireless communication device to be adaptively configured by a large variety of different users and different body placements. For example, as shown in FIG. 4, the wireless communication device 1 will curve to fit the back of a user neck when worn.

The use of several modules also serves to divide and distribute the weight of the overall wireless communication device and allow for the user of a separate adhesive for each module, thereby improving the adherence of the overall device to the user skin. The use of several modules enables the wireless communication device to be more precisely adhered to varying contours of the user's body, allowing the wireless communication device to accommodate to a variety of positions, orientations, and users, thereby enabling a reliable, stable and comfortable placement for many different users and placement locations.

Referring to FIG. 2, for each module, a double sided adhesive 58 is attached to the outer side of mating half 52. For example, the adhesive may be a medical grade adhesive designed to adhere to human skin. Referring to FIG. 3 showing a side view of the wireless communication device in a flexed position, the double sided adhesive 58 is shown attached to the outer side of mating half 52. Double sided adhesive 58 may be removed and replaced by a user as desired. Several different varieties of adhesive may be provided with the wireless communication device, such that an individual user can select one that the user finds most preferable depending upon the intended use. For example, medical grade polyethylene foam adhesive tape or cloth backed adhesives allowing for greater breathability may be used.

Referring again to FIG. 1, when the microphone 10 of the wireless communication device is located in the transmitter module 2, it is advantageous to use a microphone of the electret type. An electret microphone operates on the principle of converting sound into changes of electrical field between a metallic diaphragm and a metal back plate, which operate together as a capacitor. FIG. 1 shows an arrangement of a transmitter module 2, in which a microphone 10 is seated within mating halves 50 and 52 by means of ribs 17, which may be molded integrally with the mating halves 50 and 52 illustrated in FIG. 2. Sound is conducted to the microphone 10 by way of sound tube 11, which may be of stainless steel. Sound tube 11 is surrounded by a wire retainer where it enters the capsule. Sound tube 11 may be press-fitted to an elastomeric coupler, the other end of which is press-fitted onto the microphone 10. The user voice signals are converted to electrical signals by the microphone 10. Lead wires 14 are provided to transfer the electrical signals output by microphone 10 output to a transmitter circuit residing on PCBA 30 via a flex circuit 54. A flexible acoustic sound tube 12 is employed to pick up sound near the user's mouth and convey it into sound tube 11, thus comprising an acoustic voice tube assembly.

Flexible acoustic sound tube 12 receives sound waves from a user's voice at distal end 33 of sound tube 12, which may be covered by a windscreen 35. For example, sound tube 12 may have an internal diameter of about 1.5 mm. Beneath windscreen 35 may be an acoustic damper which serves to damp and filter selected frequency components prior to conduction to the microphone 10, and reduces standing waves in the sound tube 12.

A receiver 16 is fitted in a rubber boot 24, which in turn is placed in the receiver module 4, in the space formed between ribs 21. Other configurations may be used to hold the receiver 16 and rubber boot 24 securely within receiver module 4. Rubber boot 24 fits tightly around the receiver case to prevent sound leakage into the receiver module 4. Leads 26 are employed to conduct electrical signals from PCBA 30 via printed conductors on a flex circuit 54 to the receiver 16. An elastomeric coupler may connect the receiver 16 to a metal receiver insert 20, which passes through the module wall. An acoustic ear tube 18, conducts sound from the metal receiver insert 20 to the wearer's ear canal, in conventional manner, thus constituting an acoustic receiver tube assembly. The structures by which receiver 16 transmits sound through acoustic ear tube 18 may vary in additional examples of the invention.

An earbud 22 adapted to rest against the opening of the ear canal is placed over the acoustic ear tube 18. The earbud has a mounting member for attaching it to the acoustic ear tube 18. Earbud 22 may take one of several different configurations, to account for variations in users' ears and users' preferences. For example, earbud 22 may be made of soft rubber, with a generally mushroom-like configuration. As a further example, earbud 22 may have a foam covering and a pill-shaped configuration.

PCBA 30 includes various circuitry and processors to implement the required functionality of the wireless communication device as described herein. For example, PCBA 30 includes a device controller. The controller further includes an analog-to-digital (A/D) converter and a digital-to-analog (D/A) converter. The device controller receives input from a headset user interface via an input decoder and manages audio data received from microphone 10 and audio sent to receiver 16. The device controller further interacts with a wireless communication transceiver to transmit and receive signals to and from the wireless communication device 1. Battery 32 provides power to the various components of the wireless communication device.

The controller monitors the activity of the wireless communication device 1 and detects the occurrence of an action by a user via a user interface and responsively changes the desired setting. The controller includes memory storing programs which control the wireless communication device 1 and storing current settings.

The microphone 10 receives the user's speech, and the analog signals formed thereby are converted to a digital signal using an analog-to-digital (A/D) converter. The A/D converter may be integrated with the controller. In the reverse direction, a voice signal received from a far-end user is converted from a digital signal to an analog signal using a digital-to-analog (D/A) converter and transferred to receiver 16 for output to the near end user via acoustic ear tube 18. The controller and wireless communication transceiver, or portions thereof may be integrated in a chip set.

Wireless communication device 1 may also include a user interface and status indicators. The user interface may include a multifunction power, volume, mute, and select button or buttons. Other user interfaces may be included on the wireless communication device, such as a link active/end interface. User modifications are detected by a headset controller, which then initiates corresponding modifications. The user interface is used to modify operational settings of the headset for purposes including directly accessing configuration settings, turning the power off and on, adjusting the volume of sound emitted by the headset etc. The function of some of the user interface buttons may be dependent upon the particular operational state of the headset. It will be appreciated that a variety of user interfaces and their locations may be employed and the particular user interface is not critical to the present invention.

The PCBA module 6 contains a wireless communication transceiver which can be in the form of a digital wireless transceiver for bi-directional communication. In one example, PCBA module 6 employs a wireless communication transceiver which communications over an RF network employing the DECT standard. In a further example, PCBA module 6 employs a wireless communication transceiver which communicates over an RF network employing the Bluetooth standard with a corresponding Bluetooth module at the client device. The Bluetooth specification includes a profile for implementing TCP/IP over the Bluetooth link. Bluetooth is a radio-frequency protocol which allows electronic devices to connect to one another over short-range radio links. Bluetooth devices operate in the ISM (industrial, scientific, medical) band at about 2.4 to 2.5 GHz, and have a range limited to about 10 meters. Spread spectrum frequency hopping limits interference from other devices using the ISM bandwidth. The Bluetooth specification, version 2.0, is hereby incorporated by reference.

A prescribed interface such as Host Control Interface (HCI) is defined between each Bluetooth module. Message packets associated with the HCI are communicated between the Bluetooth modules. Control commands, result information of the control commands, user data information, and other information are also communicated between Bluetooth modules. The wireless communication transceiver may also, for example, operate under the 802.11a, 802.11b, or related standard.

Once the wireless communication device modules are adhered to the user, it is useful to adjust sound tube 12 such that its distal end 33 is disposed generally in front of the corner of the user's mouth. This position is depicted in FIG. 4 (wireless communication device 1 is not shown to scale relative to the user). As previously noted, sound tube 12 is highly flexible and can therefore be placed as desired. In one example, the distal end 33 may be attached to the user face with a double sided adhesive 60 similar to adhesive 58 described above in reference to FIGS. 2 and 3.

The various examples described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. Such changes may include, but are not necessarily limited to: the number, shape, size and contents of the modules; the type of microphone or receiver used; wireless communication technologies, standards, and procedures to link the wireless communication device; manner of attaching the adhesive to the wireless communication device housing. Such modifications and changes do not depart from the true spirit and scope of the present invention that is set forth in the following claims.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

What is claimed is:

1-10. (canceled)

11. A communication device comprising:
a first housing;
a microphone coupled to the first housing for converting an acoustic signal to an electrical signal;
a receiver coupled to the first housing for converting an electrical signal to an acoustic signal; and
an adhesive attached to the first housing for removably adhering the first housing to a user.

12. The communication device of claim 11, further comprising a wireless transceiver disposed within the first housing.

13. The communication device of claim 12, wherein the wireless transceiver utilizes the DECT communications protocol.

14. The communication device of claim 12, wherein the wireless transceiver utilizes the Bluetooth communications protocol.

15. The communication device of claim 11, wherein the microphone is an electret microphone.

16. A communication device comprising:
a housing means;
a microphone means disposed within the housing means for converting an acoustic signal to an electrical signal;
a receiver means disposed within the housing means for converting an electrical signal to an acoustic signal; and
an adhesive means attached to the housing means for removably attaching the housing means to a user.

17. The communication device of claim 16, further comprising a wireless communication means disposed within the housing means.

18. The communication device of claim 11, wherein the microphone is disposed within a second housing.

19. The communication device of claim 18, wherein the microphone is coupled to a first sound tube.

20. The communications device of claim 19, wherein the receiver is disposed in a third housing.

21. The communications device of claim 20, wherein the receiver is coupled to a second sound tube.

22. The communications device of claim 21, farther comprising a first adhesive with a first side and a second side, wherein the first side is removably attached to an outer surface of the second housing and the second side is removably adherable to a user; and
a second adhesive with a third side and a fourth side, wherein the third side is removably attached to an outer surface of the third housing and the fourth side is removably adherable to the user.

23 The communication device of claim 22, further comprising a third adhesive attached to the first sound tube for removably adhering the first sound tube to the user.

24. The communication device of claim 22 further comprising:
a fourth housing, wherein the elastomeric gasket flexibly couples the fourth housing to the second housing and the third housing;
a wireless transceiver disposed within the fourth housing, wherein the wireless transceiver is electrically coupled to the microphone and the receiver; and
a third adhesive with a fifth side and a sixth side, wherein the fifth side is removably attached to an outer surface of the fourth housing and the sixth side is removably adherable to the user.

25. The communication device of claim 24, wherein the wireless transceiver utilizes the DECT communications protocol.

26. The communication device of claim 24, wherein the wireless transceiver utilizes the Bluetooth communications protocol.

27. The communication device of claim 22, wherein the second housing and the third housing comprise two square mating halves.

28. The communication device of claim 22, further comprising a flex circuit electrically connecting the microphone and the receiver to a transceiver circuit.

29. The communication device of claim 28, wherein the flex circuit is integrated within the elastomeric gasket.

30. The communication device of claim 22, wherein the microphone is an electret microphone.

31. The communication device of claim 22, wherein the second sound tube comprises an earbud disposed at a second sound tube distal end.
